(19) United States
(12) Patent Application Publication
(10) Pub. No.: US 2018/0189118 A1
(43) Pub. Date: Jul. 5, 2018

(54) SYSTEMS AND METHODS FOR TRANSFORMING APPLICATIONS

(71) Applicant: PowWow, Inc., San Francisco, CA (US)

(72) Inventors: Jonathan Kaplan, San Francisco, CA (US); Samir Mahendra, San Francisco, CA (US); Prasanna Venkatesh Kuppumani, Redmond, WA (US); Andrew Cohen, San Francisco, CA (US)

(21) Appl. No.: 15/741,042

(22) PCT Filed: Jun. 30, 2016
(86) PCT No.: PCT/US16/40536

§ 371 Date: Dec. 29, 2017

Related U.S. Application Data
(60) Provisional application No. 62/187,401, filed on Jul. 1, 2015.

(51) Int. Cl. G06F 9/54

(52) U.S. Cl. CPC G06F 9/541; H04L 67/141; G06F 2209/542; G06F 2209/541

(57) ABSTRACT

A system is enabled to create an application, for use by devices, by using an intermediary agent to efficiently transform an existing monitored application. The intermediary agent is configured to attach to at least one monitored application executed on at least one server and to create a session corresponding to at least one client application executed on at least one client wherein execution of the client application is at least partially based on a message between the server and the client. The intermediary agent is also configured to intercept the message to identify at least one change in the state of the monitored application and to transmit the message to a transformation module upon detection of at least one change in the state of the monitored application. The transformation module is configured to determine whether the communication message should be modified prior to being transmitted to the client.

### RELATED AND CO-PENDING APPLICATION

This application is a U.S. national stage application under U.S.C. § of International Patent Application No. PCT/US16/40536, filed Jun. 30, 2016, which claims the benefit of U.S. Provisional Patent Application No. 62/187,401 filed Jul. 1, 2015, the contents of which are incorporated herein by reference in their entirety.

### BACKGROUND

In systems, such as computing systems, at least some known applications may be designed for use on a desktop computer. These applications can, in some embodiments, utilize a desktop computer's display, mouse and keyboard to enable interaction with the user of the application. These applications may also be used on a variety of known client devices that also have a display, mouse and keyboard similar to a desktop computer or on other known client device, including handheld devices, such as mobile phone and tablets.

At least some known methods can be used to enable users to interact with applications on the various different known devices. For example, at least one known method includes rewriting the application, so an entirely new application is created for a mobile device. This new application, in some embodiments, recreates the business logic of the original application while presenting an entirely new user interface that can be used for the relatively smaller display and touch and/or gesture environment of a mobile device. However, recreating an application can be time-consuming and can require a substantial amount of effort. In other known embodiments, the existing application is used on a mobile device, either through an application, such as a web browser, or through screen replication technology, such as a virtual desktop infrastructure (“VDI”). While such a method is relatively quicker because an application is not being recreated, this method can result in a poor user experience due to, for example, using display outputs that are optimized for a larger display and mouse and keyboard interaction.

### BRIEF DESCRIPTION

The embodiments described herein provide a system that is enabled to create an application that can be used by, for example, handheld or mobile devices, by efficiently transforming an existing application. In some embodiments, a system is provided that includes at least one server that is configured to be in communication with at least one client via a network. The server includes an operating system that is configured to execute the operation of at least one application such that the client is enabled to separately launch and execute the application therein. The application continues to be executed by the client based, at least in part, on at least one communication message between the server and the client. An intermediary agent is in communication with the operating system, wherein the intermediary agent is configured to attach to the application and to create a session corresponding to the application and the client such that the client attaches to the created session when the client is launching and executing the application. The intermediary agent is also configured to intercept the communication message to obtain information regarding the state of the application and to detect whether there exists at least one change in the state of the application. The intermediary agent is also configured to transmit the message to a transformation module when at least one change in the state of the application is detected such that the communication message is modified by the transformation module prior to being transmitted to the client.

In other embodiments, a method for transforming at least one application is provided. The method includes connecting at least one server with at least one client via a network, wherein the server includes an operating system and an intermediary agent in communication with the operating system. The operation of at least one application is executed via the operating system such that the client is enabled to separately launch and execute the application therein. The application continues to be executed by the client based, at least in part, on at least one communication message between the server and the client. The intermediary agent is attached to the application. A session is created, via the intermediary agent, wherein the session corresponds to the application and the client such that the client attaches to the created session when the client is launching and executing the application. The communication message is intercepted to obtain information regarding the state of the application. The method also includes detecting whether there exists at least one change in the state of the application. The message is transmitted to a transformation module when at least one change in the state of the application is detected such that the communication message is modified by the transformation module prior to being transmitted to the client.

In other embodiments, at least one computer-readable storage medium having computer-executable instructions embodied thereon is provided, wherein, when executed by at least one processor, the computer-executable instructions cause the processor to connect with at least one client via a network and execute the operation of at least one application such that the client is enabled to separately launch and execute the application therein. The application continues to be executed by the client based, at least in part, on at least one communication message between the processor and the client. The computer-executable instructions further cause the processor to attach to the application and to create a session corresponding to the application and the client such that the client attaches to the created session when the client is launching and executing the application. The computer-executable instructions also cause the processor to intercept the communication message to obtain information regarding the state of the application and to detect whether there exists at least one change in the state of the application. The computer-executable instructions further cause the processor to transmit the message to a transformation module when at least one change in the state of the application is detected such that the communication message is modified by the transformation module prior to being transmitted to the client.

### BRIEF DESCRIPTION OF THE DRAWINGS

FIG. 1 is a block diagram of an exemplary system having one or more servers communicating with one or more clients;

FIG. 2 is a swimlane diagram of an exemplary method for transforming at least one application using the system shown in FIG. 1;

FIG. 3 is a swimlane diagram of an exemplary method for synchronization of state changes between applications that can be used with the system shown in FIG. 1;

FIG. 4 is a block diagram of the exemplary states that can be used in monitoring the applications that can be used with the system shown in FIG. 1; and

FIG. 5 is an flow diagram of an exemplary transformation of data from at least one application that can be used with the system shown in FIG. 1.

### DETAILED DESCRIPTION

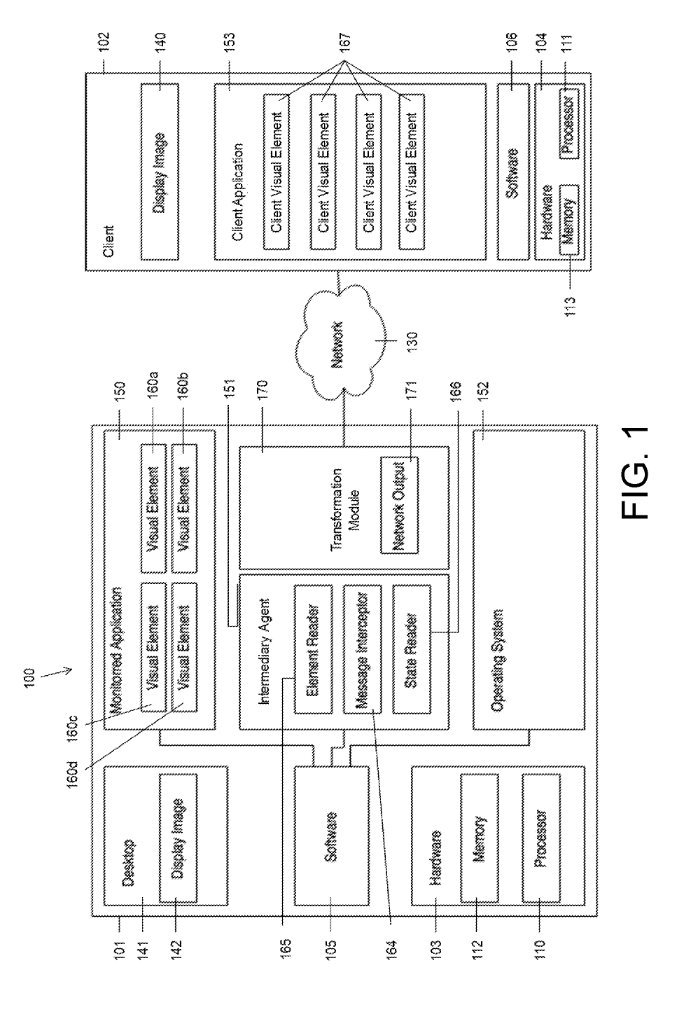

FIG. 1 illustrates an exemplary system 100 that includes one or more physical computer systems or hosts, such as server 101, and one or more clients, such as client 102. In some embodiments, server 101 and client 102 include hardware units 103 and 104, respectively, and software 105 and software 106, respectively. Software 105 and software 106 run on hardware units 103 and 104, respectively, such that various applications or programs can be executed on hardware units 103 and 104 by way of respective software 105 and 106. In some embodiments, the functions of software 105 and 106 can be implemented directly in respective hardware units 103 and 104, e.g., as a system-on-a-chip, firmware, field-programmable gate array (FPGA), etc. In some embodiments, hardware units 103 and 104 each includes one or more processors, such as processor 110 and processor 111, respectively. In some embodiments, processors 110 and 111 are each an execution unit, or “core,” on a microprocessor chip. In some embodiments, processors 110 and 111 may each include a processing unit, such as, without limitation, an integrated circuit (IC), an application specific integrated circuit (ASIC), a microcomputer, a programmable logic controller (PLC), and/or any other programmable circuit. Alternatively, processors 110 and 111 may each include multiple processing units (e.g., in a multi-core configuration). The above examples are exemplary only, and, thus, are not intended to limit in any way the definition and/or meaning of the term “processor.”

Each hardware unit 103 and 104 also includes a system memory 112 and 113, respectively. Each memory 112 and 113 can be a general volatile random access memory (RAM). For example, each hardware unit 103 and 104 can include a 32 bit microcomputer with 2 Mbit ROM and 64 Kbit RAM. Each memory 112 and 113 can also be a read-only memory (ROM), a network interface (NIC), and/or other device(s).

Client 102 may be a remote terminal, such as a desktop computer, laptop, mobile device, tablet, thin client, or other device having a communications interface that can communicate with server 101 using, for example, a network 130. Network 130 can be the Internet, a local area network (LAN), a wide area network (WAN), a personal area network (PAN), or any combination thereof, and network 130 can transmit information between server 101 and client 102 at different rates or speeds. Client 102 can also be capable of displaying applications based on data from software 105 running inside server 101 using, for example, at least one display image 140 or other output device(s). In some embodiments, client 102 may also be capable of receiving user input from the respective end user and transmitting the received user input to server 101. In some embodiments, client 102 may be capable of communicating with server 101 via network 130.

Software 106 of client 102 includes one or more modules or applications, including a client application 153. In some embodiments, client application 153 includes a plurality of module or application elements, such as a plurality of client visual elements 167.

In some embodiments, server 101 can output at least one desktop, such as desktop 141, to a user of or in communication with server 101. Desktop 141 can be an interactive user environment provided by an operating system and/or applications running within respective server 101, and generally includes one or more screens or display images, such as display image 142, but may include other outputs such as audio (not shown), indicator lamps (not shown), tactile feedback (not shown), etc. Each desktop 141 can also accept input from the user in the form of device inputs, such as keyboard and mouse inputs. In some embodiments, desktop 141 can also accept simulated inputs, such as simulated keyboard and mouse inputs. In addition to user input and/or output, desktop 141 can send and receive device data, such as input and/or output for a FLASH memory device (not shown) local to the user, or to a local printer (not shown).

Software 105 includes one or more modules or applications, including a monitored application 150 and an intermediary agent 151. In addition, software 105 can enable or facilitate running an operating system, such as operating system 152. Monitored application 150 can include various sub-modules, including visual elements 160a, 160b, 160c, and 160d (collectively referred to as “visual elements 160”) and can interact with an operating system 152. In some embodiments monitored application 150 can interact with operating system 152. Operating system 152 can be any type of operating system 152, such as Microsoft Windows®, in which case operating system 152 relies on an application container, such as a Microsoft Windows® application container. Microsoft Windows® is a registered trademark of Microsoft Corporation of Redmond, Wash. In other embodiments, operating system 152 may be a constrained software execution environment such as a web browser or virtual machine (not shown in FIG. 1).

In some embodiments, intermediary agent 151 monitors monitored application 150. For example, intermediary agent 151 may include a message interceptor 164, an element reader 165, and a state reader 166, to enable intermediary agent 151 to monitor the state of monitored application 150. For example, in some embodiments, the monitoring can be done by intercepting outgoing messages sent from monitored application 150 via message interceptor 164. In other embodiments, intermediary agent 151 monitors the state of monitored application 150 by reading visual elements 160 via element reader 165. In still other embodiments, intermediary agent 151 monitors the state of monitored application 150 by querying the visual state of monitored application 150 via state reader 166.

A transformation module 170 processes any state changes to monitored application 150 and subsequently modifies the data for use by client 102, and further formats the data for transmission over network 130. In some embodiments, data can be transmitted to a separate client application (e.g., client application 153) where it is rendered as a display image, such as display image 140. In some embodiments, transformation module 170 is configured to generate a network output 171.

System 100 can be implemented on one or more physical enterprises or a desktop computer system, such as a work or home computer that is remotely accessed when travelling. Alternatively, system 100 may be implemented on a virtual desktop infrastructure (VDI) that has a plurality of virtual machines (VMs) (not shown). For example, in some embodiments, transformation module 170 can be connected to a plurality of VMs on server 101. In a VDI deployment, desktop 141 can be exported from a corresponding one of the VMs to client 102. In such an embodiment, software implemented processes 105 and 106 can each be virtualization software and the VMs can be executed on respective hardware 103 and 104 by way of the virtualization software. It should therefore be understood that the present disclosure can be implemented in a variety of contexts, but may be particularly useful wherever graphical user interface remote displaying is implemented.

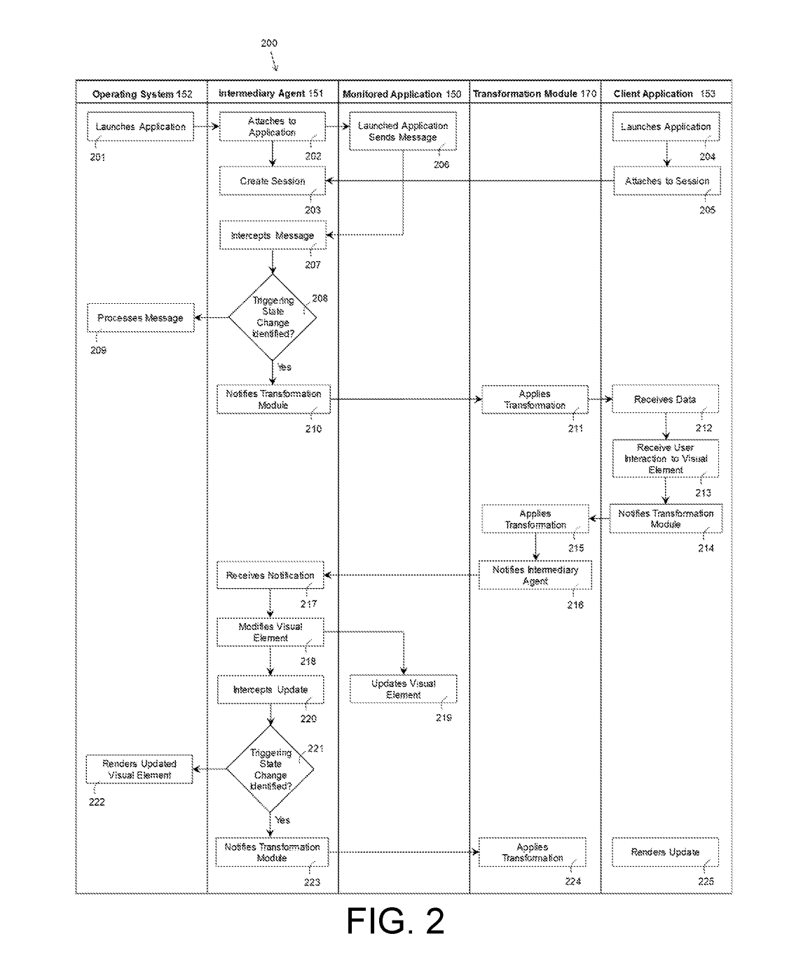

As explained in more detail below with respect to FIGS. 2-5, by transmitting data to client 102 based on various state triggers (not shown in FIG. 1), system 100 is able to optimally display applications on client 102, that are being executed on sever 101, without having to rebuild monitored application 150.

FIG. 2 is a swimlane diagram 200 of an exemplary method for configuring one or more applications using system 100. This method may be embodied within a plurality of computer-executable instructions stored in one or more memories, such as one or more computer-readable storage mediums. Computer storage mediums include non-transitory media and may include volatile and nonvolatile, removable and non-removal mediums implemented in any method or technology for storage of information such as computer readable instructions, data structures, program modules or other data. The instructions may be executed by one or more processor to perform the functions herein.

In some embodiments, server 101 and client 102 (both shown in FIG. 1) establish communication channels via network 130 (shown in FIG. 1). The channel(s) facilitate communication between intermediary agent 151 (shown in FIG. 1) and transformation module 170 (shown in FIG. 1) for transmittal over network 130, such that data from monitored application 150 (shown in FIG. 1) can be modified and shared between server 101 and client 102. In some embodiments, these connections are established automatically when any application starts up, and may be automatically re-established as needed when the connection is lost or server 101 restarts.

In operation 201, operating system 152 (shown in FIG. 1) launches operation of monitored application 150 on server 101. In operation 202, intermediary agent 151 attaches to monitored application 150. In operation 203, intermediary agent 151 creates a session corresponding to monitored application 150. In operation 204, client 102 separately launches client application 153 (shown in FIG. 1). In some embodiments client application 153 is separately launched and operated on client 102 and continues to be executed by client 102 based, at least in part, on at least one communication message sent between intermediary agent 151 and transformation module 170. In operation 205, intermediary agent 151 attaches client application 153 to the corresponding session in monitored application 150 on server 101.

In operations 206, after having been launched, monitored application 150 sends at least one message to operating system 152. In operation 207, intermediary agent 151 intercepts the message sent by monitored application 150 in order to collect information about monitored application 150, such as the known state of monitored application 150. In operation 208, intermediary agent 151 recognizes the state that monitored application 150 has entered into and identifies whether there has been a triggering state change that needs to be communicated to transformation module 170. Regardless of whether a state change has been identified, in operation 209, intermediary agent 151 transmits the message to operating system 152 such that message can be processed therein.

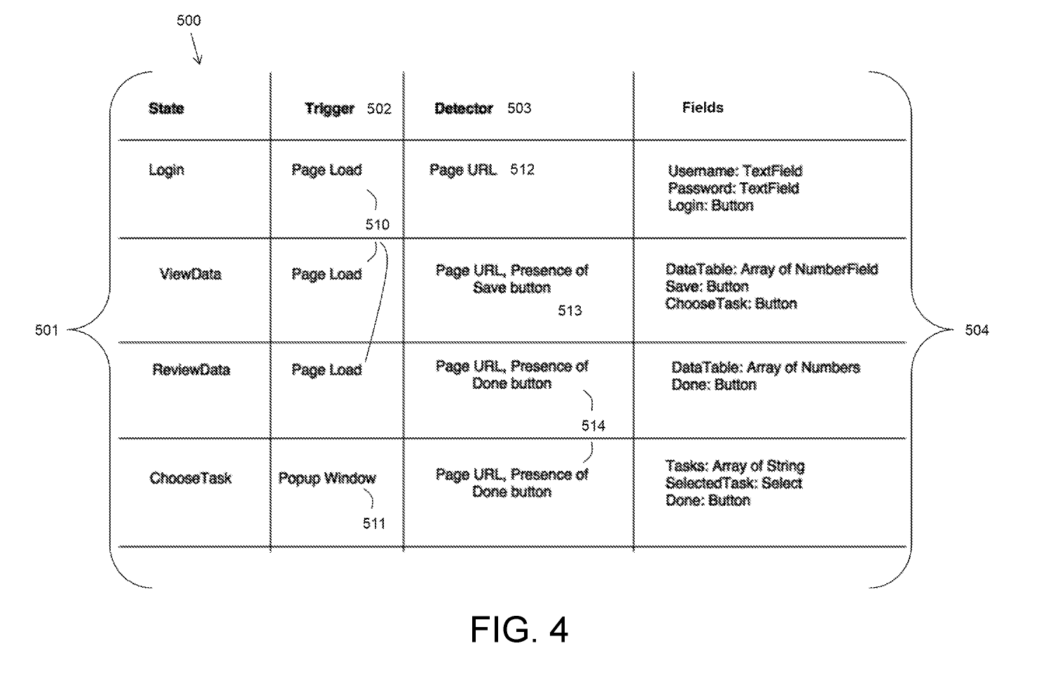

Moreover, if intermediary agent 151 identifies that there has been a triggering state change during operation 208 (as further described in FIG. 4), then, in operation 210, intermediary agent 151 transmits a notification of the change in state of monitored application 150 to transformation module 170.

In other embodiments, intermediary agent 151 may intercept different functions or parameters of monitored application 150 to collect information about the known state of monitored application 150, including but not limited to intercepting the creation of visual elements 160 (shown in FIG. 1).

In operation 211, transformation module 170 applies a transformation based on the notification received from intermediary agent 151. In some embodiments, the transformation applied by transformation module 170 includes the modification of data suited by client 102, such as for a particular mobile device, and/or includes the removal of necessary data prior to transmitting the data over network 130 to client application 153, such as a mobile application.

In operation 212, client application 153 receives data transmitted over network 130 and renders data to display in a state appropriately suited for client 102, such as for a particular mobile device. In some embodiments, the appropriately suited display of the data includes utilizing client visual elements 167 and or displaying the data in different sequences or formats suitable for client display 140 (shown in FIG. 1). For example, in some embodiments, a state may contain ten visual elements, such as visual elements 160, in monitored application 150, and the state may be represented as two separate states on client application 153, wherein each state displays only five visual elements, such as visual elements 160.

In operation 213, client application 153 receives data based on user interaction with client visual elements 167 (shown in FIG. 1). In other embodiments, the user interaction client 102 may involve other client application elements (not shown) instead of client visual elements 167. In operation 214, client application 153 notifies transformation module 170 of at least one state change based on user interaction with client application 153. In operation 215, transformation module 170 applies a transformation to the data generated from user interaction. In some embodiments, the transformation applied to client application 153 includes the modification of data for a particular computing device and/or the removal of necessary data prior to transmitting data over network 130 to monitored application 150. In operation 216, after the data has been transformed, transformation module 170 transmits the data to intermediary agent 151. In operation 217, intermediary agent receives notification of the transformed data. In operation 218, intermediary agent 151 modifies monitored application 150 based on the notification sent by transformation module 170, which was triggered by user interaction with client 102. In operation 219, monitored application 150 updates visual elements 160 via an application programming interface (API) or message (both are not shown).

In operation 220, an update to visual elements 160 of monitored application 150 is intercepted by intermediary agent 151. In operation 221, intermediary agent 151 identifies whether there has been a triggering state change (as further described in FIG. 4) in monitored application 150. Regardless of whether a triggering state change exists, in operation 222, notification is sent to operating system 152 such that an updated visual element can be rendered by operating system 152. Moreover, when a triggering state change has occurred, then, in operation 223, intermediary agent 151 sends a message notifying transformation module 170 of the state change. In operation 224, transformation module 170 applies the requisite transformation to generate an updated visual element data prior to sending it to client 102. In operation 225, transformation module 170 sends the transformed updated visual element data to client application 153 on client 102 over network 130 such that the updated state can be rendered on client application 152.

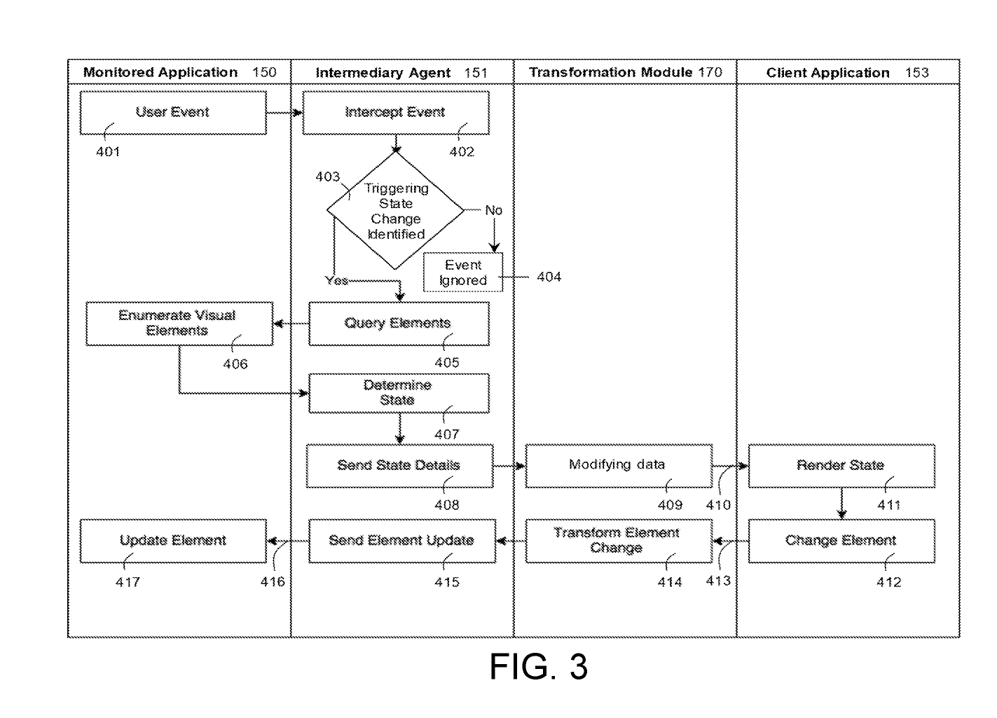

FIG. 3 is a swimlane diagram illustrating an exemplary interaction between intermediary agent 151 (shown in FIGS. 1 and 2) and any common agent interface (not shown in FIG. 3) in order to detect state changes in, for example, monitored application 150 (shown in FIGS. 1 and 2).

In operation 401, a user interacts with monitored application 150. In operation 402, intermediary agent 151 intercepts a user interaction to determine whether monitored application 150 has changed its state. In operation 403, a determination in made as to whether the event is a state trigger. For example, the change of state may result due to a response from a user interaction (as shown). In other embodiments, the change of state may result for a variety of reasons, including the application starting up or a timer timing out, etc. In operation 404, if the event is not a state trigger, the intercepted user interaction is ignored.

Alternatively, if the event is a state trigger, then, in operation 405 intermediary agent 151 employs common agent interface to query the visual elements 160 (shown in FIG. 1). In operation 406, monitored application enumerates visual elements 160 on display image 142 (shown in FIG. 1). In operation 407, intermediary agent 151 determines the current state of the monitored application 150 based on the state trigger event received in operation 401 as well as based on the set of visual elements 160 detected by common agent interface and enumerated by monitored application 150 in operations 405 and 406. In some embodiments, intermediary agent 151 determines the state of monitored application 150 by recording the details of monitored application 150, including the value and state of each individual visual elements 160 on the screen.

In operation 408, intermediary agent 151 sends a message to transformation module 170 (shown in FIGS. 1 and 2) notifying transformation module 170 of the state change in monitored application 150. In operation 409, transformation module 170 modifies the data, such as state details. In operation 410, transformation module 170 transmits the transformed information to client application 153 (shown in FIGS. 1 and 2).

In operation 411, client application 153 processes the transmitted notification about the updated state of monitored application 150. In some embodiments, client application 153 may ignore this event. In alternative embodiments, client application 153 may modify its internal state. In other embodiments, client application 153 may render an updated state that is visible to the user, as shown in operation 412 below.

In operation 412, client application 153 renders an updated user interface based on receipt of one or more user interactions (not shown). In some embodiments, receipt of user interactions causes client application 153 to change state. In operation 413, client application 153 notifies transformation module 170 of the state change in client application 153. In operation 414, after receiving a message indicating a change of the state in client application 153, transformation module 170 modifies the data of client application 153. In operation 415, transformation module 170 sends the updated state change and modified data to intermediary agent 151. In operation 416, common agent interface interfaces with intermediary agent 151 to make an appropriate change to monitored application 150. For example, intermediary agent 151 may set the value of some visual elements of monitored application 150, and may also use, for example, mouse interactions (not shown), to further modify visual elements, such as visual elements 160. In operation 417, monitored application 150 is updated.

FIG. 4 illustrates an exemplary diagram 500 of states used by intermediary agent 151 (shown in FIGS. 1, 2, and 3) to monitor the state of monitored application 150 (shown in FIGS. 1, 2, and 3). In some embodiments, each state consists of four features: a name to identify the state 501; (2) a trigger 502 that causes intermediary agent 151 to determine that a state change has occurred; (3) a detector 503 that is used to detect a particular state after the trigger is intercepted by intermediary agent 151; and (4) a set of fields 504 for intermediary agent 151 to read, to determine value of, and to include in the state update message that intermediary agent 151 sends to transformation module 170 (shown in FIGS. 1, 2, and 3).

In some embodiments, each of the states illustrated in diagram 500 correlates to any known type of web application, such as a monitored web application (not shown). State triggers in the monitored web application can include, but are not limited to: an internet browser (e.g., any known internet browser) loading a new page 510; an internet browser displaying a popup window 511; or an internet browser detecting a change in the DOM of a currently displayed web page (not shown). Once a state change is determined to have occurred, one or more state detectors 503 in the web application are used to determine the current state. In some embodiments, state detectors 503 for the monitored web application include, but are not limited to: (a) a URL of the currently loaded page (512); (b) presence of one or more components such as a “Save” prompt (513) or a “Done” prompt (514); or (c) a particular text embedded in the web page.

After the state of a monitored application 150 is determined, a message is sent to transformation module 170. In some embodiments, this message includes information about all visual elements 160 (shown in FIG. 1) of interest in the current state of monitored application 150. In some embodiments, wherein visual elements 160 correspond to a monitored web application (not shown), fields 504 include, but are not limited to, identifiers of objects in the DOM as well as their type. This may include identifiers, such as usernames, passwords, logins, data tables, etc. After a state change occurs, the state, values, and metadata of fields 504 are queried and sent to transformation module 170.

Diagram 500 is not limited to identifying states, triggers, detectors, and fields for a web application (not shown). In alternative embodiments, similar diagrams are employed by intermediary agent 151 to determine the state of different types of applications.

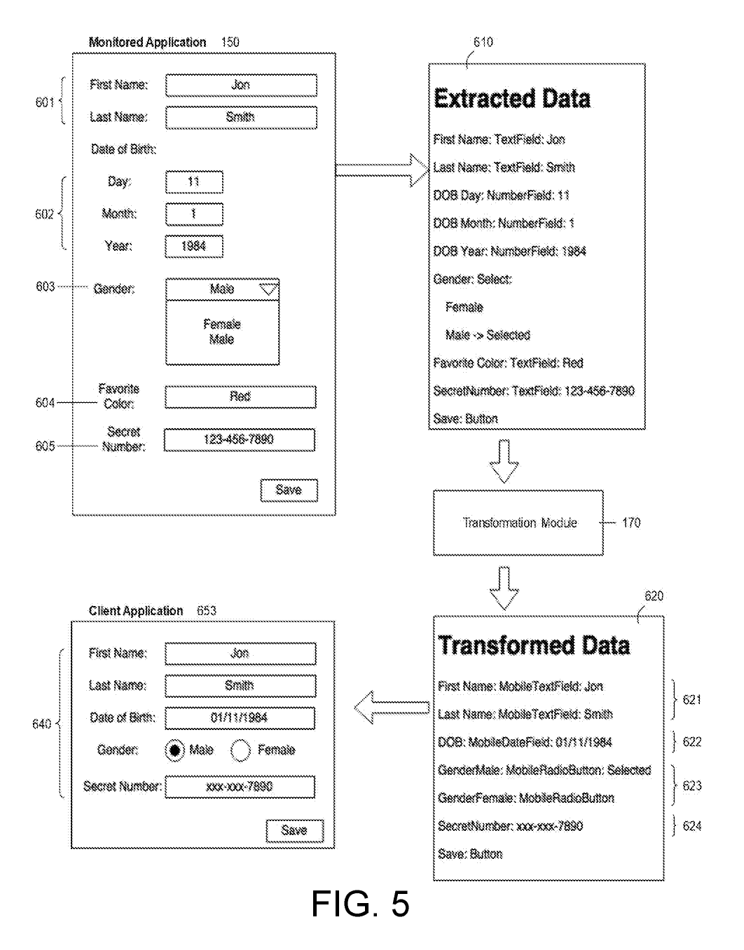

FIG. 5 illustrates an example of how data may be extracted from a monitored application and be modified by transformation module 170 (shown in FIGS. 1, 2, and 3) prior to being transmitted to client application 153 (as shown in FIGS. 1, 2, and 3).

In some embodiments, monitored application 150 (shown in FIGS. 1, 2, and 3) may include a plurality of fields, such as field 601 for “First Name, Last Name,” and field 602 for “Day, Month, and Year” of the user's date of birth. Some embodiments may also include field 603 for “gender” and additional fields 604 and 605 for “Favorite Color” and “Secret Number”, respectively.

Referring to FIG. 5, fields 601, 602, 603, 604 and 605, identified in monitored application 150, are all queried by intermediary agent 151 (shown in FIGS. 1, 2, and 3) so as to generate extracted data 610. In some embodiments, extracted data 610 contains an identifier, a field type, and a current value for corresponding data fields. In some embodiments, for one select field, all valid values will be included in extracted data 610. In other embodiments, extracted data 610 may further include information including metadata regarding the field's enabled or disabled state. In some embodiments, transformation module 170 uses a set of rules to determine what data to send to client application 153.

In some embodiments, client 102 may be a mobile device running a mobile client application 653 wherein transformation module 170 modifies monitored application 150 data based on the needs in mobile client application 653. In some embodiments, transformation module 170 may convert field 601, for a user's first and last name, to a transformed field 621, modified specifically for the needs of mobile client application 653. For example, transformed field 621 may be optimized for use on mobile client application 653 with respect to gesture and touch environment. In some embodiments, transformation module 170 may combine the three individual values associated with the day, month, and year features of fields 602, for a user's date of birth, into a single value transformed field 622. In alternative embodiments, transformation module 170 may convert field 603, utilizing a drop-down menu for gender selection to a set of MobileRadioButtons 623 that do not require a user to use multiple taps for gender selection. In some embodiments, transformation module 170 may remove the “favorite color” field 604, as it is not needed in mobile client application 653, thereby saving bandwidth of transmitting extra data to client 102. In other embodiments, transformation module 170 may mask data in the secret number field 605 (depicted as “Xs” in a transformed field 624), ensuring that the full value is not sent over network 130 (shown in FIGS. 1, 2, and 3), thereby enhancing security of mobile client application 653.

In some embodiments, a transformed set of data fields 620 generated by transformation module 170 is sent over network 130 to mobile client application 653. In some embodiments, mobile client application 653 renders the updated state pursuant to the transformations made by transformation module 170, via mobile user interface 640. The layout of mobile user interface 640 may be significantly different than monitored application 150, for example, mobile user interface 640 may show data in a different order or across a different number of screens (not shown).

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the disclosure may be useful machine operations. In addition, one or more embodiments of the disclosure also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present disclosure may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

In addition, as mentioned above, one or more embodiments of the present disclosure may also be provided with a virtualization infrastructure. While virtualization methods may assume that virtual machines present interfaces consistent with a particular hardware system, virtualization methods may also be used in conjunction with virtualizations that do not correspond directly to any particular hardware system. Virtualization systems in accordance with various embodiments, implemented as hosted embodiments, non-hosted embodiments or as embodiments that tend to blur distinctions between the two, are all envisioned. Furthermore, various virtualization operations may be wholly or partially implemented in hardware, or implemented with traditional virtualization or paravirtualization techniques. Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A system comprising at least one server configured to be in communication with at least one client via a network, wherein said at least one server comprises:
an application module that is configured to execute the operation of at least one application such that said at least one client is enabled to separately launch and execute the at least one application therein, wherein the application is continued to be executed by said at least one client based, at least in part, on at least one communication message between said at least one server and said at least one client;
an intermediary agent in communication with said application module, wherein said intermediary agent is configured to:
attach to the at least one application;
create a session corresponding to the at least one application and the at least one client such that said at least one client attaches to the created session when said at least one client is launching and executing the at least one application;
intercept the at least one communication message to obtain information regarding the state of the at least one application;
detect whether there exists at least one change in the state of the at least one application; and
transmit the at least one message to a transformation module when at least one change in the state of the at least one application is detected, wherein the transformation module is configured to determine whether the at least one communication message should be modified prior to being transmitted to said at least one client.

2. The system of claim 1, wherein said application module is configured to execute the operation of the at least one application by being configured to:
enable the display of at least one visual element; and
enable a reaction to the at least one communication message.

3. The system of claim 1, wherein said intermediary agent is configured to detect whether there exists at least one change in the state of the at least one application by being configured to detect whether there exists at least one recognizable change.

4. The system of claim 1, wherein said at least one server comprises the transformation module therein.

5. The system of claim 1, further comprising at least one different server comprising the transformation module therein.

6. The system of claim 1, wherein said intermediary agent is further configured to:
receive at least one notification from the transformation module, wherein the at least one notification includes at least one modification related to at least one user interaction received from said at least one client; and
modify the at least one application based on the at least one notification received.

7. The system of claim 6, wherein said intermediary agent is configured to modify the at least one application by being configured to change at least one visual element.

8. The system of claim 6, wherein said intermediary agent is configured to modify the at least one application by being configured to use at least one application program interface related to the at least one application.

9. A method for transforming at least one application, said method comprising:
connecting at least one server with at least one client via a network, wherein the at least one server includes an application module and an intermediary agent in communication with the application module;
executing the operation of at least one application via the application module such that the at least one client is enabled to separately launch and execute the at least one application therein, wherein the application is continued to be executed by the at least one client based, at least in part, on at least one communication message between the at least one server and the at least one client;
attaching the intermediary agent to the at least one application;
creating, via the intermediary agent, a session corresponding to the at least one application and the at least one client such that the at least one client attaches to the created session when the at least one client is launching and executing the at least one application;
intercepting the at least one communication message to obtain information regarding the state of the at least one application;
detecting whether there exists at least one change in the state of the at least one application; and
transmitting the at least one message to a transformation module when at least one change in the state of the at least one application is detected, wherein the transformation module is configured to determine whether the at least one communication message should be modified prior to being transmitted to said at least one client.

10. The method of claim 9, wherein executing the operation of at least one application comprises:
enabling the display of at least one visual element; and
enabling a reaction to the at least one communication message.

11. The method of claim 9, wherein detecting whether there exists at least one change in the state of the at least one application comprises detecting whether there exists at least one recognizable change.

12. The method of claim 9, wherein the at least one server includes the transformation module therein.

13. The method of claim 9, wherein the transformation module is contained within at least one different server.

14. The method of claim 9, further comprising:
receiving at least one notification from the transformation module, wherein the at least one notification includes at least one modification related to at least one user interaction received from the at least one client; and
modifying the at least one application based on the at least one notification received.

15. The method of claim 14, wherein modifying the at least one application comprises changing at least one visual element.

16. The method of claim 14, wherein modifying the at least one application comprises using at least one application program interface related to the at least one application.

17. At least one computer-readable storage medium having computer-executable instructions embodied thereon, wherein, when executed by at least one processor, the computer-executable instructions cause the at least one processor to:
connect with at least one client via a network;
execute the operation of at least one application such that the at least one client is enabled to separately launch and execute the at least one application therein, wherein the application is continued to be executed by the at least one client based, at least in part, on at least one communication message between the at least one processor and the at least one client;
attach to the at least one application;
create a session corresponding to the at least one application and the at least one client such that the at least one client attaches to the created session when the at least one client is launching and executing the at least one application;
intercept the at least one communication message to obtain information regarding the state of the at least one application;
detect whether there exists at least one change in the state of the at least one application; and
transmit the at least one message to a transformation module when at least one change in the state of the at least one application is detected, wherein the transformation module is configured to determine whether the at least one communication message should be modified prior to being transmitted to said at least one client.

18. The at least one computer-readable storage medium of claim 17, wherein the computer-executable instructions cause the at least one processor to execute the operation of at least one application by causing the at least one processor to:
enable the display of at least one visual element; and
enable a reaction to the at least one communication message.

19. The at least one computer-readable storage medium of claim 17, wherein the computer-executable instructions further cause the at least one processor to:
receive at least one notification from the transformation module, wherein the at least one notification includes at least one modification related to at least one user interaction received from the at least one client; and
modify the at least one application based on the at least one notification received.

20. The at least one computer-readable storage medium of claim 19, wherein the computer-executable instructions cause the at least one processor to modify the at least one application by causing the at least one processor to change at least one visual element.
